(19) United States
(12) Patent Application Publication
(10) Pub. No.: US 2021/0027642 A1
(43) Pub. Date: Jan. 28, 2021

(54) INTERCONNECTING ALPHABET TOY

(71) Applicant: Sirous Dior, Bayswater (NZ)

(72) Inventor: Sirous Dior, Bayswater (NZ)

(21) Appl. No.: 16/937,062

(22) Filed: Jul. 23, 2020

Related U.S. Application Data
(60) Provisional application No. 62/878,843, filed on Jul. 26, 2019.

(51) Int. Cl. G09B 1/36; G09B 1/38

(52) U.S. Cl. CPC G09B 1/36; G09B 1/38

(57) ABSTRACT

An interconnecting alphabet toy corresponding to at least one letter from a book, including a plurality of main bodies, at least one protruding portion disposed on at least a portion of at least one side of at least one first of the plurality of main bodies, and at least one protrusion-receiving groove disposed on at least a portion of at least another side of at least one second of the plurality of main bodies to receive the at least one protruding portion therein, such that the at least one first of the plurality of main bodies and the at least one second of the plurality of main bodies interconnect to form the at least one letter.

### CROSS REFERENCE TO RELATED APPLICATION

This application claims the benefit of, and incorporates by reference, U.S. provisional patent application Ser. No. 62/878,843, entitled “Interconnecting Alphabet Toy,” which was filed on Jul. 26, 2019.

### BACKGROUND

### 1. Field

The present general inventive concept relates generally to a toy, and particularly, to an interconnecting alphabet toy.

### 2. Description of the Related Art

Children's toys can provide entertainment and educational value to a child that stimulates creativity and imagination. Additionally, children's toys facilitate an understanding about different aspects of the world around the child.

Unfortunately, new developments of educational toys and activities that require physical interaction have declined due to an increase in electronic toys in the children's toy industry. Specifically, there are no interactive, educational toys that teach alphabet learning.

Therefore, there is a need for toys for children that encourage creative learning using alphabet letters, such that the alphabet letters teach children how the world and the environment is structured. Also, interconnecting alphabet letters teach children how people communicate using principle lines of the letters.

### SUMMARY

The present general inventive concept provides an interconnecting alphabet toy that teaches children how the world is structured through the way we communicate by using interconnecting alphabet letters to teach children the principle lines, and to understand the basic foundation to drawing and structures.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an interconnecting alphabet toy corresponding to at least one letter from a book, including a plurality of main bodies, at least one protruding portion disposed on at least a portion of at least one side of at least one first of the plurality of main bodies, and at least one protrusion-receiving groove disposed on at least a portion of at least another side of at least one second of the plurality of main bodies to receive the at least one protruding portion therein, such that the at least one first of the plurality of main bodies and the at least one second of the plurality of main bodies interconnect to form the at least one letter.

Each of the plurality of main bodies may deform in response to a force applied thereto.

The at least one protruding portion may be a magnetic surface.

The at least one protrusion-receiving groove may be a magnetic surface.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates an exploded view of an interconnecting alphabet toy, according to an exemplary embodiment of the present general inventive concept;

FIG. 1B illustrates a top isometric view of the interconnecting alphabet toy, according to an exemplary embodiment of the present general inventive concept;

FIG. 1C illustrates a front view of the interconnecting alphabet toy, according to an exemplary embodiment of the present general inventive concept;

FIG. 1D illustrates a top view of the interconnecting alphabet toy, according to an exemplary embodiment of the present general inventive concept;

FIG. 1E illustrates a bottom view of the interconnecting alphabet toy, according to an exemplary embodiment of the present general inventive concept;

FIG. 1F illustrates a side view of the interconnecting alphabet toy, according to an exemplary embodiment of the present general inventive concept;

FIG. 2 illustrates a top perspective view of a plurality of main bodies of the interconnecting alphabet toy, according to an exemplary embodiment of the present general inventive concept; and

FIG. 3 illustrates a plan view of a book illustrating the plurality of main bodies of the interconnecting alphabet toy, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Interconnecting Alphabet Toy 100
Main Bodies 110
First Side 110a
Second Side 110b
Third Side 110c
Fourth Side 110d
Fifth Side 110e
Sixth Side 110f
Protruding Portion 120
Protrusion-Receiving Groove 130

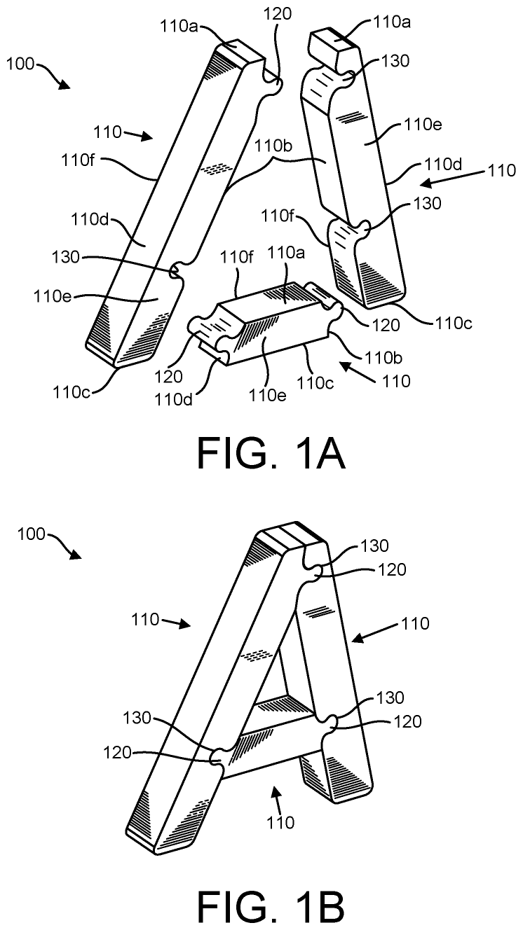

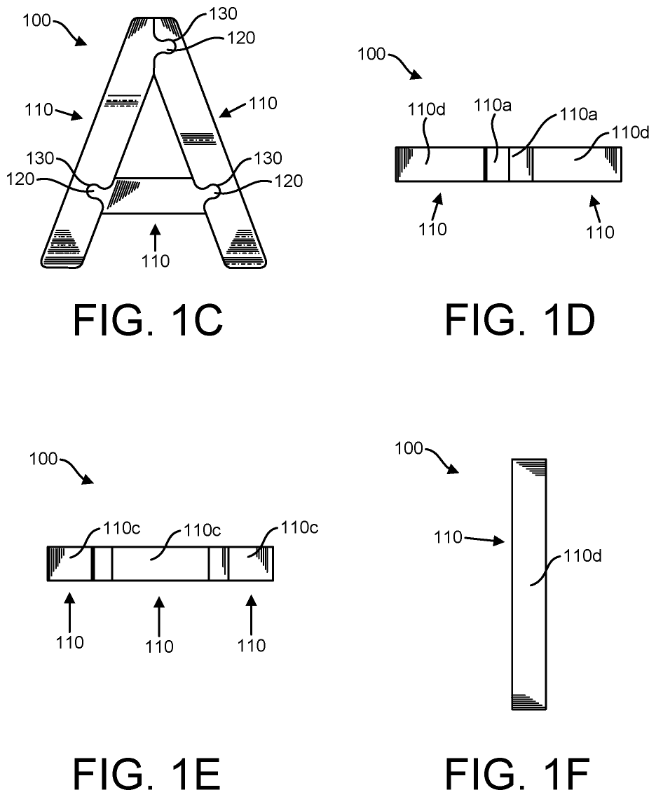

FIG. 1A illustrates an exploded view of an interconnecting alphabet toy 100, according to an exemplary embodiment of the present general inventive concept.

FIG. 1B illustrates a top isometric view of the interconnecting alphabet toy 100, according to an exemplary embodiment of the present general inventive concept.

FIG. 10 illustrates a front view of the interconnecting alphabet toy 100, according to an exemplary embodiment of the present general inventive concept.

FIG. 1D illustrates a top view of the interconnecting alphabet toy 100, according to an exemplary embodiment of the present general inventive concept.

FIG. 1E illustrates a bottom view of the interconnecting alphabet toy 100, according to an exemplary embodiment of the present general inventive concept.

FIG. 1F illustrates a side view of the interconnecting alphabet toy 100, according to an exemplary embodiment of the present general inventive concept.

The interconnecting alphabet toy 100 may be constructed from at least one of metal, plastic, wood, glass, and rubber, etc., but is not limited thereto. Alternatively and/or in addition to, at least a portion of the interconnecting alphabet toy 100 may be magnetic, but is not limited thereto.

The interconnecting alphabet toy 100 may include a plurality of main bodies 110, at least one protruding portion 120, and at least one protrusion-receiving groove 130, but is not limited thereto.

Each of the plurality of main bodies 110 may be constructed to be hard and/or soft. As such, at least a portion of each of the plurality of main bodies 110 may deform in response to a force applied to a surface thereof. In other words, at least a portion of each of the plurality of main bodies 110 may be flexible. Furthermore, each of the plurality of main bodies 110 may return to an original shape in response to removal of the force applied thereupon.

Each of the plurality of main bodies 110 may include a first side 110a, a second side 110b, a third side 110c, a fourth side 110d, a fifth side 110e, and a sixth side 110f, but is not limited thereto.

At least a portion of at least one of the first side 110a, the second side 110b, the third side 110c, the fourth side 110d, the fifth side 110e, and the sixth side 110f may have a smooth surface and/or a textured surface, such as a plurality of bubbled protrusions extending away therefrom. As such, the textured surface may facilitate gripping thereof.

The at least one protruding portion 120 may be disposed on at least a portion of at least one of the first side 110a, the second side 110b, the third side 110c, the fourth side 110d, the fifth side 110e, and the sixth side 110f.

The at least one protrusion-receiving portion 130 may be disposed on at least a portion of at least one of the first side 110a, the second side 110b, the third side 110c, the fourth side 110d, the fifth side 110e, and the sixth side 110f.

Referring to FIGS. 1A and 1B, at least one first main body 110 may be aligned with at least one second main body 110 and at least one third main body 110. Specifically, at least a portion of the at least one protruding portion 120 of the at least one first main body 110 may be inserted into the at least one protrusion-receiving portion 130 of the at least one second main body 110. Additionally, at least one first protruding portion 120 and at least one second protruding portion 120 of at least one third main body 110 may be inserted into the at least one protrusion-receiving portion 130 corresponding to the at least one first main body 110 and the at least one protrusion-receiving portion 130 corresponding to the at least one second main body 110, respectively.

Alternatively, the at least one protruding portion 120 and the at least one protrusion-receiving portion 130 may be a magnetic surface and/or an adhesive substrate, such that the at least one first main body 110, the at least one second main body 110, and/or the at least one third main body 110 may removably interconnect via the magnetic surface and/or the adhesive substrate.

Referring again to FIGS. 1A and 1B, therefore, each of the plurality of main bodies 110 may removably interconnect to form at least one letter, such as a letter “A,” but is not limited thereto. As such, each of the plurality of main bodies 110 may form a horizontal portion, a vertical portion, a semicircular portion, and/or a circulation portion with respect to another of the plurality of main bodies 110.

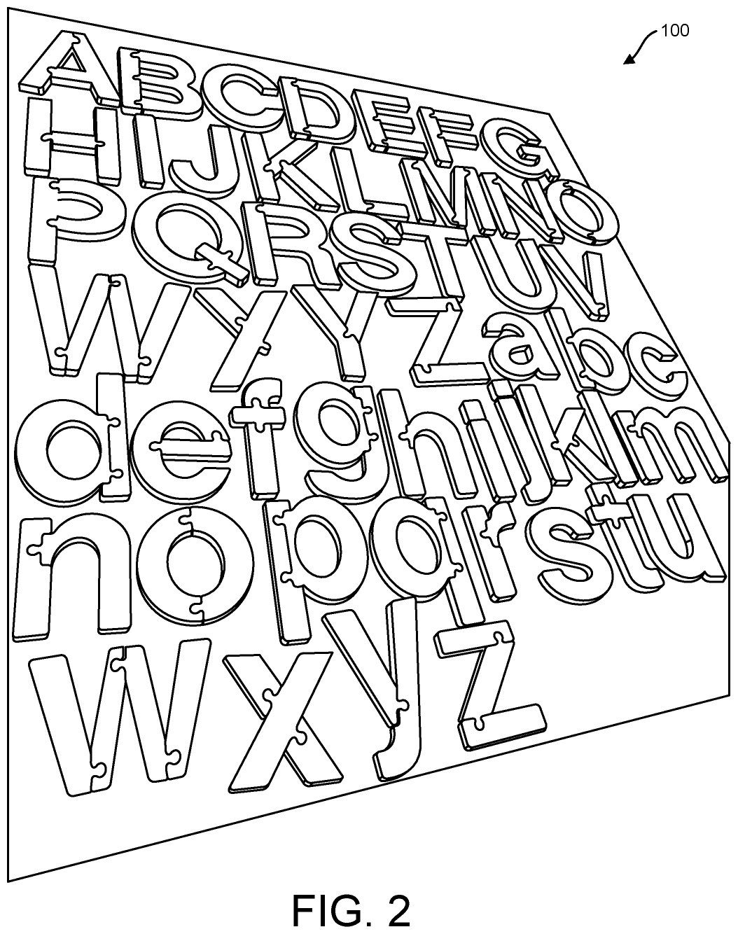

FIG. 2 illustrates a top perspective view of a plurality of main bodies 110 of the interconnecting alphabet toy 100, according to an exemplary embodiment of the present general inventive concept.

Alternatively, each of the plurality of main bodies 110 may interconnect to form at least one of a letter “B,” “C,” “D,” “E,” “F,” “G,” “H,” “I,” “J,” “K,” “L,” “M,” “N,” “O,” “P,” “Q,” “R,” “S,” “T,” “U,” “V,” “W,” “X,” “Y,” and “Z.” Furthermore, the at least one letter may be an uppercase and/or a lowercase letter.

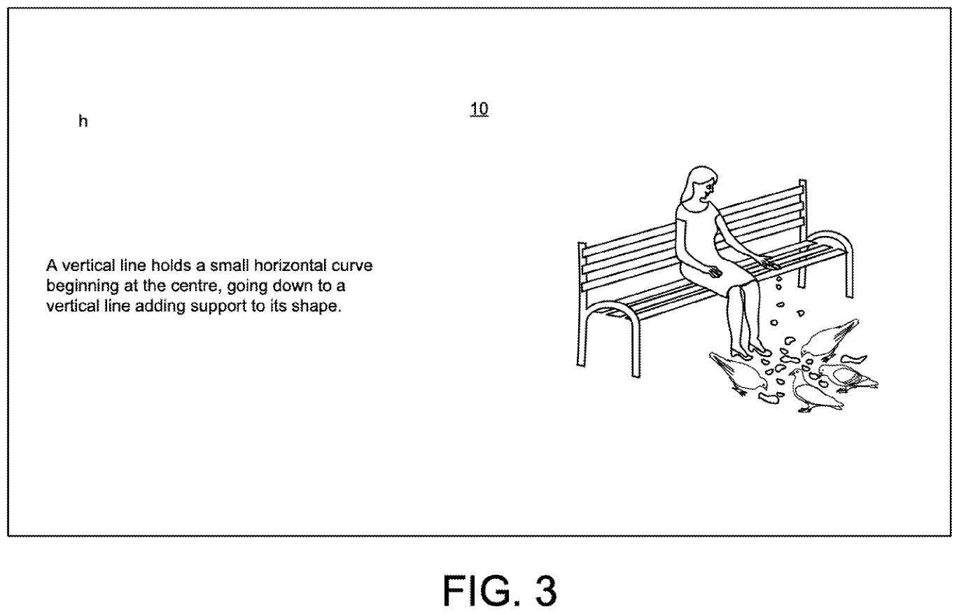

FIG. 3 illustrates a plan view of a book 10 illustrating the plurality of main bodies 110 of the interconnecting alphabet toy 100, according to an exemplary embodiment of the present general inventive concept.

A book 10 may educate a user of a visual representation of the interconnecting alphabet toy 100 in an environment. For example, the book 10 may illustrate a lowercase letter “h” on a chair to help the user learn the lowercase letter “h,” as well as, learning about the environment.

Therefore, the interconnecting alphabet toy 100 may enhance creativity by creating letters and new shapes. The interconnecting alphabet toy 100 may appeal to a variety of users, such as children in kindergarten, Montessori schools, pre-school, and/or elementary school. Also, parents and users with dyslexia may use the interconnecting alphabet toy 100. As such, the interconnecting alphabet toy 100 may at least partially enhance learning an alphabet using a physical and/or a visual construct without recalling a written definition.

The present general inventive concept may include an interconnecting alphabet toy 100 corresponding to at least one letter from a book 10, including a plurality of main bodies 110, at least one protruding portion 120 disposed on at least a portion of at least one side of at least one first of the plurality of main bodies 110, and at least one protrusion-receiving groove 130 disposed on at least a portion of at least another side of at least one second of the plurality of main bodies 110 to receive the at least one protruding portion 120 therein, such that the at least one first of the plurality of main bodies 110 and the at least one second of the plurality of main bodies 110 interconnect to form the at least one letter.

Each of the plurality of main bodies 110 may deform in response to a force applied thereto.

The at least one protruding portion 120 may be a magnetic surface.

The at least one protrusion-receiving groove 130 may be a magnetic surface.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An interconnecting alphabet toy corresponding to at least one letter from a book, comprising:
a plurality of main bodies;
at least one protruding portion disposed on at least a portion of at least one side of at least one first of the plurality of main bodies; and
at least one protrusion-receiving groove disposed on at least a portion of at least another side of at least one second of the plurality of main bodies to receive the at least one protruding portion therein, such that the at least one first of the plurality of main bodies and the at least one second of the plurality of main bodies interconnect to form the at least one letter.

2. The interconnecting alphabet toy of claim 1, wherein each of the plurality of main bodies deforms in response to a force applied thereto.

3. The interconnecting alphabet toy of claim 1, wherein the at least one protruding portion is a magnetic surface.

4. The interconnecting alphabet toy of claim 1, where the at least one protrusion-receiving groove is a magnetic surface.
